(19) United States
(12) Patent Application Publication
(10) Pub. No.: US 2025/0272687 A1
(43) Pub. Date: Aug. 28, 2025

(54) INTELLIGENT ALGORITHM SYSTEM FOR PAYMENT

(71) Applicant: XUHUI CAI, SINGAPORE (SG)

(72) Inventor: XUHUI CAI, SINGAPORE (SG)

(21) Appl. No.: 18/585,224

(22) Filed: Feb. 23, 2024

(51) Int. Cl. G06Q 20/40

(52) U.S. Cl. CPC G06Q 20/4016

(57) ABSTRACT

An intelligent algorithm system for payment is provided and includes: a transaction monitoring module, configured to monitor transaction data of a user; a risk assessment module, connected to the transaction monitoring module and configured to process the transaction data of the user and provide a warning about transaction data that is abnormal after being processed; a data mining module, connected to the risk assessment module and configured to analyze and mine a large amount of payment data and mark any risk point; and a storage component, connected to the transaction monitoring module, the risk assessment module, and the data mining module; and configured to store received data.

### TECHNICAL FIELD

The present disclosure relates to a technical field of online payment, and in particular to an intelligent algorithm system for payment.

### BACKGROUND

As the big data technology is continually upgrading and the mobile application technology is increasingly popular, efficiencies and costs cooperatively drive development of overall intelligence. A payment system is an important part of an economic and financial system. A safe and efficient payment system enables various financial markets to cooperate with each other lively, improves financial services, promotes financial innovation, promotes economic growth, and meets growing demands from the public for payment services, facilitates prevention of financial risks, and maintains financial stability.

When an intelligent payment system in the art is being in use, a user submits a payment application, and a payment platform recommends, from a number of payment methods, an optimal payment method to the user to be selected by the user. In this process, security and an efficiency of the payment is low, and a risk of fraud may occur during transactions. Therefore, user experience is poor, and an intelligent algorithmic system for payment is provided herein.

### SUMMARY OF THE DISCLOSURE

The present disclosure provides an intelligent algorithm system for payment to solve the above technical problems.

In a first aspect, an intelligent algorithm system for payment is provided and includes:
a transaction monitoring module, configured to monitor transaction data of a user;
a risk assessment module, connected to the transaction monitoring module and configured to process the transaction data of the user and provide a warning about transaction data that is abnormal after being processed;
a data mining module, connected to the risk assessment module and configured to analyze and mine payment data and mark any risk point; and
a storage component, connected to the transaction monitoring module, the risk assessment module, and the data mining module; and configured to store data transmitted by the transaction monitoring module, the risk assessment module, and the data mining module.

In some embodiments, the transaction monitoring module is configured to: collect data related to all transactions; classify the collected data; monitor each of the all transactions in real time; record abnormal data in the collected data; and transmit data, which is in the transaction monitoring module, the risk assessment module, and the data mining module, to the storage component.

In some embodiments, the transaction monitoring module is configured to transmit the collected data to the risk assessment module, and the risk assessment module is configured to process the received data and classify the data processed by the risk assessment module into a plurality of risk levels. The plurality of risk levels comprise a risk level I, a risk level II, and a risk level III.

In some embodiments, each of the plurality of risk levels corresponds to one respective processing measure; when a target transaction is classified to be the risk level I, transaction data of the target transaction is directly released; when the target transaction is classified to be the risk level II, the transaction data of the target transaction is intercepted and is to be manually verified; and when the target transaction is classified to be the risk level III, the transaction data of the target transaction is directly blocked.

In some embodiments, the data mining module is configured to identify abnormal transaction information by analyzing the transaction data of the user, mark a portion where the abnormal transaction information exists, integrate all of the abnormal transaction information, and identify a change in the data in normal transaction patterns.

In some embodiments, the data mining module is configured to monitor the transaction data in real time and mark potential problems or abnormalities, and mine historical data to predict and analyze future trends and risks.

According to the intelligent algorithm system for payment in the present disclosure, various data related to transactions are collected. The collected data are analyzed and are classified into various risk levels. The risk assessment module performs different measures for transactions of different risk levels. In this way, when the user is performing the payment, the payment channel and the payment information are not leaked.

### BRIEF DESCRIPTION OF THE DRAWINGS

In order to illustrate technical solutions in embodiments of the present disclosure or in the related art more clearly, the accompanying drawings for the embodiments will be briefly described in the following. Apparently, the accompanying drawings in the following description show only some of the embodiments in the present disclosure, and any ordinary skilled person in the art may obtain other drawings based on these drawings.

FIG. 1 is a block diagram of an overall principle of an intelligent algorithm system for payment according to one embodiment of the present disclosure.

Reference numerals in the drawing: 1: Transaction monitoring module; 2. Risk assessment module; 3. Data mining module; 4. Storage component; 5. Processing unit.

### DETAILED DESCRIPTION

Technical solutions in the embodiments of the present disclosure will be described clearly and completely in the following by referring to the accompanying drawings of the present disclosure. Apparently, the described embodiments are only a part of but not all of the embodiments of the present disclosure. All other embodiments, which are obtained by any ordinary skilled person in the art based on the embodiments in the present disclosure without making creative work, shall fall within the scope of the present disclosure.

In the specification of the present disclosure, it is noted that terms “center”, “up”, “down”, “left”, “right”, “vertical”, “horizontal”, “inside”, “outside” and the like indicate orientations or positional relationships based on those shown in the accompanying drawings. The terms are used to describe the present disclosure and to simplify the description, instead of indicating or suggesting that the referred device or element must be arranged in the particular orientation or configured and operated in the particular orientation. Therefore, the terms shall not be interpreted as limiting the present disclosure. Terms “first”, “second” and “third” are used for descriptive purposes only and shall to be interpreted as indicating or implying relative significance. In addition, unless otherwise expressly specified and limited, terms “mount”, “connect” and “link” shall be interpreted broadly. For example, the terms can indicate fixed connection, detachable connection, or connection into an integral and one-piece structure; mechanical connection, electrical connection; direct connection; or indirect connection through an intermediate medium; or connection of two internal elements. Any ordinary skilled person in the art shall understand specific meanings of the above terms based on specific contexts of the present disclosure.

### Embodiments

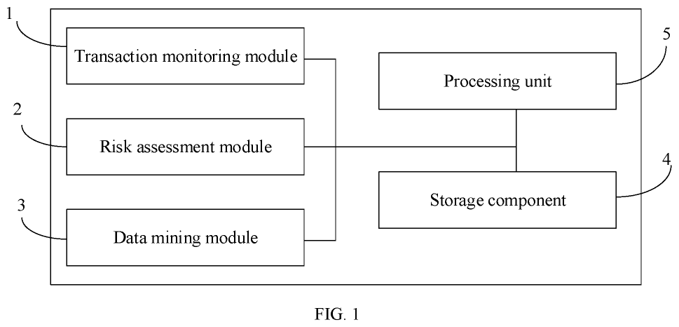

As shown in FIG. 1, an intelligent algorithm system for payment includes a transaction monitoring module 1, configured to monitor transaction data of a user.

The transaction monitoring module 1 collects data related to all transactions; classifies the collected data; monitors each of all transactions in real time; records abnormal data of the collected data; and stores data, which is transmitted by the transaction monitoring module, a risk assessment module, and a data mining module.

In the present embodiment, transaction information is monitored in real time. The monitoring module monitors a payment transaction process in real time, monitors and analyzes each transaction in real time, ensuring that any abnormality is detected in time. At the same time, the monitoring module collects the data related to the all transactions from a payment system. The data related to the all transactions include the amount of each transaction, information of both parties of each transaction, a time point of each transaction, and so on. The collected data is used for subsequent analysis and determination.

At the same time, an elliptic curve cryptography (ECC) algorithm is used to protect the transactions. The elliptic curve refers to a curve determined by the Weierstrass Equation as follows:

$${y}^{2} + {a}_{1} xy + {a}_{3} y = {x}^{3} + {a}_{2} {x}^{2} + {a}_{4} x + {a}_{6}$$

For the elliptic curve, either a prime field or a binary field can be applied. Since the elliptic curve cryptographic algorithm in the prime field can be implemented more easily in software and has relatively lower requirements for hardware, the elliptic curve in the prime field Z_{P} is applied in the present disclosure to enable an ECC-based mobile payment prototype system to be achieved on mobile phones. In the elliptic curve, the P is a large prime number, and all variables and coefficients of the elliptic curve are determined by a finite field (the prime field). Therefore, the above equation is simplified to obtain an equation of: y²=x³+ax+b.

All points that satisfy the above elliptic curve are denoted as EP(a, b). Points P(x₁, y₁) and Q(x₂, y₂) are two points of the EP(a, b), and P≠Q, P≠−P. In this case, P+Q=(x₃, y₃)∈Eₚ(a, b), and 2P=(x₄, y₄)∈Eₚ(a, b) and the x₃, y₃, x₄, y₄ meet the following:

$$\{ \begin{matrix}{x}_{3} = {λ}^{2} - {x}_{2} - {x}_{1} \\ {y}_{3} = λ ( {x}_{1} - {x}_{3} ) - {y}_{1}\end{matrix} λ = \frac{{y}_{2} - {y}_{1}}{{x}_{2} - {x}_{1}} \{ \begin{matrix}{x}_{4} = {λ}^{2} - 2 {x}_{1} \\ {y}_{4} = λ ( {x}_{1} - {x}_{4} ) - {y}_{1}\end{matrix} λ = \frac{3 {x}_{1}^{2} + \text{?}}{2 {y}_{1}}$$

$$\text{?} \text{indicates text missing or illegible when filed}$$

As described in the above, point multiplication is a fundamental operation of the elliptic curve. For an integer K and a point of the finite field P∈Eₚ(a, b), the point multiplication is defined as Q=KP, and Q∈Eₚ(a, b) The KP is a result of performing point addition on the point P for K times. Therefore, when the point multiplication is involved in the above equation, the indicated point addition and the point multiplication are repeatedly performed.

Further, the transaction process is monitored in real time and is protected.

Further, the risk assessment module 2, which is connected to the transaction monitoring module 1, is configured to process the transaction data of the user and provide a warning for transaction data that is abnormal after being processed.

The transaction monitoring module 1 transmits the collected data to the risk assessment module 2, and the risk assessment module 2 processes the received data and classifies the data that is processed by the risk assessment module 2 into a plurality of risk levels. The plurality of risk levels include a risk level I, a risk level II, and a risk level III.

In the present embodiment, by collecting the data related to all transactions, such as the amount of each transaction, information of both parties of each transaction, and the time point of each transaction, and so on, data support is provided for the subsequent risk assessment and determination. The risk assessment module 2 performs processing measures, such as releasing, intercepting and manually verification, for transactions of different risk levels to ensure security and reliability of each transaction.

Further, different risk levels correspond to different processing measures. When a transaction is classified to be the risk level I, the transaction data is directly released. When a transaction is classified to be the risk level II, the transaction data is intercepted and is to be manually verified. When a transaction is classified to be the risk level III, the transaction data is directly blocked.

Specifically, various of identity verification methods can be performed in the transaction process to ensure that identities of both parties of the transaction are true and effective. At the same time, a risk assessment is performed on the user, based on historical transaction records of the user, behavioral patterns of the user, and other relevant information, to provide a corresponding risk level and a corresponding transaction amount limit for the user. A real-time monitoring mechanism is set up to instantly analyze and make determination on the transaction data. When an abnormal or high-risk transaction is detected, the system immediately performs appropriate measures to terminate the transaction.

A graph neural network (GNN) model is applied. Firstly, node embedding vectors is input to a multi-layer perceptron (MLP) to obtain a vector of each node consisting of a respective score under a respective category. Subsequently, for each central node that is input in a batch in a current iteration, a distance from the central node to each neighboring node I₁ is calculated based on the equation:

$${D}^{( l )} ( v , u ) = {‖ σ ( {MLP}^{( l )} ( {h}_{v}^{( l - 1 )} ) ) - σ ( {MLP}^{( l )} ( {h}_{u}^{( l - 1 )} ) ) ‖}_{l} .$$

The D^{(l)}(v, u) denotes, in the l-th layer, the distance I₁ between the central node v and the neighboring nodes u∈N(v). Similarity between the central node and the neighboring nodes is defined as follows: S⁽¹⁾(v, u)=1−D⁽¹⁾(v, u). Each layer has an independent similarity measurement module. When an overall average distance between the nodes under the above relationship r is decreasing, it is indicated that the similarity between the central node and the neighboring nodes is increasing, i.e., more similar nodes are present around the central node. In this case, a node percentage Pᵣ⁽¹⁾ for aggregation can be increased, richer information can be extracted, and a type of the central node is determined. On the contrary, the distance being increasing indicates that too many dissimilar nodes are aggregated, and the dissimilar nodes mask features of the central node.

In the above, multi-relational aggregation is applied, and that is, a process of updating the embedded vectors representing the features of the nodes includes into two steps. An intra-relational aggregation is performed under each relationship and is defined as follows:

$${h}_{v , r}^{( l )} = {AGG}_{r}^{( l )} ( \{ {h}_{u}^{( l - 1 )} , u ∈ N ( v ) , {e}_{u , v} ∈ {E}_{r} \} ) .$$

The h_{v,u}^{(l)} denotes, in the l-the layer, an aggregated embedding vector of the central node v under the relationship r after performing the intra-relational aggregation and nonlinear transformation. The AGGᵣ^{(l)}(.) denotes an aggregation function, and in this case, an averaging operation is performed. The e_{u,v} denotes that a border is present between nodes. When the intra-relational aggregation step is completed, the embedding vector {h_{v,1}^{(l)}, h_{v,2}^{(l)}, . . . , h_{v, R}^{(l)}} under each relationship is obtained. Subsequently, the node percentage Pᵣ^{(l)} for aggregation of each relationship is taken as a weight of the respective relationship, and inter-relational aggregation is performed based on the respective weight as follows: hᵥ^{(l)}=σ(hᵥ^{(l-1)}+AGG^{(l)}({Pᵣ^{(l)}·h_{v,r}^{(l)}}ᵣ₌₁^{R}).

The hᵥ^{(l)} denotes the embedding vector of the central node after the l-th layer update.

Further, a plurality of fraud samples are recorded and learnt. In this way, when the risk assessment module 2 is used subsequently, the risk assessment module 2 provides a timely warning for any potentially fraudulent transaction to alert the user and a payment institution to avoid losses.

Further, the data mining module 3, which is connected to the risk assessment module 2, analyzes and mines a large amount of payment data and marks any risk point.

The data mining module 3 identifies abnormal transaction information by analyzing the transaction data of the user, marks a portion where the abnormal transaction information exists, integrates all of the identified abnormal transaction information, and identifies a change in the data in normal transaction patterns.

In the present disclosure, the data mining module 3 identifies an abnormal transaction pattern by analyzing the transaction data. For example, when a sudden large-amount transaction and an off-site transaction are identified, the data mining module 3 discovers potential risks in time, processes the discovered risks, and marks information of the transaction, facilitating prevention of fraud transactions.

Further, the data mining module 3 monitors the transaction data in real time and marks potential problems or abnormalities, and mines the historical data, allowing future trends and risks to be predicted and analyzed.

Specifically, the data mining module 3 monitors the transaction data in real time, marks potential problems or anomalies, and performs corresponding measures in time, avoiding losses to the user.

Further, the storage component 4, which is connected to the transaction monitoring module 1, the risk assessment module 2, and the data mining module 3, is configured to store the received data.

In the present disclosure, the storage component 4 is connected to the processing unit 5, and the processing unit 5 protects the payment.

The storage component 4 may be a universal serial bus (USB) flash drive, but is not limited to a system of electricity, magnetism, light, electromagnetism, infrared or semiconductors, or a system or a device, or any combination of the above. More specific examples of a computer-readable storage media includes, but are not limited to: electrical connection having one or more wires, a portable computer disk, a portable computer hard disk, a random access memory (RAM), a read-only memory (ROM), an erasable programmable read-only memory, an optical fiber, a portable compact disk read only memory (CD ROM), an optical storage device, a magnetic storage device, or any suitable combination of the above. In the present embodiment, the computer-readable storage medium may be any tangible medium that contains or stores programs, and the programs can be executed by an instruction execution system, a system, a device, or a combination thereof. Program codes contained in the computer-readable storage medium can be transmitted by any suitable medium, including but not limited to: wires, fiber optic cables, radio frequency (RF), and so on, or by any suitable combination thereof.

The above describes only certain exemplary embodiments of the present disclosure, and any ordinary skilled person in the art can amend the described embodiments in various ways without departing from the spirit and scope of the present disclosure. Therefore, the above drawings and description are illustrative and shall not be interpreted as limiting the scope of the claims of the present disclosure.

What is claimed is:

1. An intelligent algorithm system for payment, comprising:
a transaction monitoring module, configured to monitor transaction data of a user;
a risk assessment module, connected to the transaction monitoring module and configured to process the transaction data of the user and provide a warning about transaction data that is abnormal after being processed;
a data mining module, connected to the risk assessment module and configured to analyze and mine payment data and mark any risk point; and
a storage component, connected to the transaction monitoring module, the risk assessment module, and the data mining module; and configured to store data transmitted from the transaction monitoring module, the risk assessment module, and the data mining module.

2. The intelligent algorithm system for payment according to claim 1, wherein the transaction monitoring module is configured to collect data related to all transactions, classify the collected data, monitor each of the all transactions in real time, record abnormal data in the collected data, and transmit data, which is in the transaction monitoring module, the risk assessment module, and the data mining module, to the storage component.

3. The intelligent algorithm system for payment according to claim 2, wherein the transaction monitoring module is configured to transmit the collected data to the risk assessment module; the risk assessment module is configured to process the received data and classify the data that is processed by the risk assessment module into a plurality of risk levels; and the plurality of risk levels comprise a risk level I, a risk level II, and a risk level III.

4. The intelligent algorithm system for payment according to claim 3, wherein each of the plurality of risk levels corresponds to a respective processing measure; when a target transaction is classified to be the risk level I, transaction data of the target transaction is directly released; when the target transaction is classified to be the risk level II, the transaction data of the target transaction is intercepted and is to be manually verified; and when the target transaction is classified to be the risk level III, the transaction data of the target transaction is directly blocked.

5. The intelligent algorithm system for payment according to claim 1, wherein the data mining module is configured to identify abnormal transaction information by analyzing the transaction data of the user, mark a portion where the abnormal transaction information exists, integrate all of the abnormal transaction information, and identify a change in the data in normal transaction patterns.

6. The intelligent algorithm system for payment according to claim 5, wherein the data mining module is configured to monitor the transaction data in real time and mark potential problems or abnormalities, and mine historical data to predict and analyze future trends and risks.
